(19) United States
(12) Patent Application Publication
(10) Pub. No.: US 2014/0375515 A1
(43) Pub. Date: Dec. 25, 2014

(54) FREQUENCY TUNABLE ANTENNA

(71) Applicant: BlackBerry Limited, Waterloo (CA)

(72) Inventors: Meide QIU, Ottawa (CA); Qinjiang RAO, Kanata (CA)

(73) Assignee: BlackBerry Limited, Waterloo (CA)

(21) Appl. No.: 13/922,355

(22) Filed: Jun. 20, 2013

(51) Int. Cl. H01Q 1/36

(52) U.S. Cl. CPC H01Q 1/36
USPC 343/745

(57) ABSTRACT

A frequency tunable antenna is provided. Specifically, a device is provided that includes: a ground; an antenna feed; a first radiating arm connected to the antenna feed; a second radiating arm capacitively coupled to the first radiating arm; a switch connected to the second radiating arm, the switch having an open position and a closed position; an inductor connected to the switch on one side and the ground on an opposite side, and, a processor in communication with the switch, the processor configured to open and close the switch to tune a resonance frequency of at least the second radiating arm thereby changing a resonant length of the second radiating arm depending on whether the inductor is connected thereto.

### FIELD

The specification relates generally to antennas, and specifically to a frequency tunable antenna.

### BACKGROUND

Current mobile electronic devices, such as smartphones, tablets and the like, generally have different antennas implemented to support different types of wireless protocols and/or to cover different frequency ranges. For example, LTE (Long Term Evolution) bands, GSM (Global System for Mobile Communications) bands, UMTS (Universal Mobile Telecommunications System) bands, and/or WLAN (wireless local area network) bands, cover frequency ranges from 700 to 960 MHz, 1710-2170 MHz, and 2500-2700 MHz and the specific channels within these bands can vary from region to region necessitating the use of different antennas for each region in similar models of devices. This can complicate both resourcing and managing the different antennas for devices in each region.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a schematic diagram of a device that includes a frequency tunable antenna, according to non-limiting implementations.

FIG. 2 depicts a schematic diagram of frequency tunable antenna that can be used in the device of FIG. 1, with a switch in an open position, according to non-limiting implementations.

FIG. 3 depicts a schematic diagram of frequency tunable antenna that can be used in the device of FIG. 1, with a switch in a closed position, according to non-limiting implementations.

FIG. 4 depicts a schematic diagram of an alternative frequency tunable antenna that can be used in the device of FIG. 1, with a switch in an open position, according to non-limiting implementations.

FIG. 5 depicts a schematic diagram of yet a further alternative frequency tunable antenna that can be used in the device of FIG. 1, with a switch in an open position, according to non-limiting implementations.

FIG. 6 depicts a return-loss curve of the frequency tunable antenna of FIG. 5, with an 8.2 nH inductor connecting a second radiating arm to ground, according to non-limiting implementations.

FIG. 7 depicts a return-loss curve of the frequency tunable antenna of FIG. 5, with a 6.8 nH inductor connecting a second radiating arm to ground, according to non-limiting implementations.

FIG. 8 depicts a return-loss curve of the frequency tunable antenna of FIG. 5, with a 3.9 nH inductor connecting a second radiating arm to ground, according to non-limiting implementations.

FIG. 9 depicts a return-loss curve of the frequency tunable antenna of FIG. 5, with a 2.2 nH inductor connecting a second radiating arm to ground, according to non-limiting implementations.

FIG. 10 depicts efficiency curves of the frequency tunable antenna of FIG. 5, over a frequency range of about 700 MHz to about 960 MHz, with each of four inductors for each of the conditions of FIGS. 6 to 9, according to non-limiting implementations.

FIG. 11 depicts details of the efficiency curves of FIG. 10, according to non-limiting implementations.

### DETAILED DESCRIPTION

The present disclosure describes examples of a frequency tunable antenna that can resonate at three frequency responses to cover bands that include channels for LTE bands, GSM bands, UMTS bands, and/or WLAN bands in a plurality of geographical regions. Furthermore, the frequency response of at least the lowest frequency band can be precisely tuned.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

Furthermore, as will become apparent, in this specification certain elements may be described as connected physically, electronically, or any combination thereof, according to context. In general, components that are electrically connected are configured to communicate (that is, they are capable of communicating) by way of electric signals. According to context, two components that are physically coupled and/or physically connected may behave as a single element. In some cases, physically connected elements may be integrally formed, e.g., part of a single-piece article that may share structures and materials. In other cases, physically connected elements may comprise discrete components that may be fastened together in any fashion. Physical connections may also include a combination of discrete components fastened together, and components fashioned as a single piece.

Furthermore, as will become apparent in this specification, certain antenna components may be described as being configured for generating a resonance at a given frequency and/or resonating at a given frequency and/or having a resonance at a given frequency. In general, an antenna component that is configured to resonate at a given frequency, and the like, can also be described as having a resonant length and/or a radiation length, an electrical length and the like corresponding to the given frequency. The electrical length can be similar to or different from a physical length of the antenna component. However, the electrical length of the antenna component can also be different from the physical length, for example by using electronic components to effectively lengthen the electrical length as compared to the physical length. However, the term electrical length is most often used with respect to simple monopole and/or dipole antennas. The resonant length can be similar to, or different from, the electrical length and the physical length of the antenna component. In general, the resonant length corresponds to an effective length of an antenna component used to generate a resonance at the given frequency; for example, for irregularly shaped and/or complex antenna components that resonate at a given frequency, the resonant length can be described as a length of a simple antenna component, including but not limited to a monopole antenna and a dipole antenna, that resonates at the same given frequency.

An aspect of the specification provides a device comprising: a ground; an antenna feed; a first radiating arm connected to the antenna feed; a second radiating arm capacitively coupled to the first radiating arm; a switch connected to the second radiating arm, the switch having an open position and a closed position; an inductor connected to the switch on one side and the ground on an opposite side; and, a processor in communication with the switch, the processor configured to open and close the switch to tune a resonance frequency of at least the second radiating arm thereby changing an resonant length of the second radiating arm depending on whether the inductor is connected thereto.

The device can further comprise a second inductor connecting the second radiating arm to the ground in series, the second inductor connected in parallel with the inductor, the second radiating arm configured to compensate for loss of the switch.

The device can further comprise: a plurality of switches, including the switch, and a plurality of inductors, including the inductor, the plurality of switches connected to the second radiating arm, each of the plurality of switches having a respective open position and a respective closed position, each of the plurality of inductors connectable to the second radiating arm via a respective switch of the plurality of switches, the plurality of inductors connected in parallel to the ground. The processor can be in communication with the plurality of switches, and the processor can be further configured to open and close the plurality of switches to tune the resonance frequency of at least the second radiating arm thereby changing the resonant length of the second radiating arm depending on which of the plurality of inductors is connected thereto. The plurality of inductors can comprise at least four inductors, and the plurality of switches can comprise at least one of: a single pole four throw switch; a single pole double throw switch; and the single pole double throw switch in parallel with a single pole single throw switch. The plurality of inductors can include at least one inductor having an inductance of about 8.2 nH. The plurality of inductors can include at least one inductor having an inductance of about 6.8 nH. The plurality of inductors can include at least one inductor having an inductance of about 3.9 nH. The plurality of inductors can include at least one inductor having an inductance of about 2.2 nH.

The resonance frequency can be tunable to at least one of the following frequency bands, depending on an inductance of the inductor: about 700 MHz to about 746 MHz; about 746 MHz to about 787 MHz; about 824 MHz to about 94 MHz; and, about 880 MHz to about 960 MHz.

The inductor can have an inductance in a range of about 0 nH to about 100 nH.

The first radiating arm and the second radiating arm can be further configured to resonate in a first frequency range from about 1710 MHz to about 2170 MHz, and in a second frequency range from about 2500 MHz to about 2700 MHz. Each of the first frequency range and the second frequency range can be tunable depending on an inductance of the inductor.

The second radiating arm can include a trace that is about 16.2 mm long.

The second radiating arm can be coupled to the first radiating arm across a gap that in a range of about 0.5 mm to about 2 mm.

A respective size and shape of each of the first radiating arm and the second radiating arm, and a gap for capacitive coupling there between, can be chosen such the first radiating arm and the second radiating arm resonate in at least frequency ranges of: about 700 to about 960 MHz. about 1710 MHz to about 2170 MHz, and about 2500 MHz to about 2700 MHz; wherein the positions of resonances are tunable based on an inductance of the inductor.

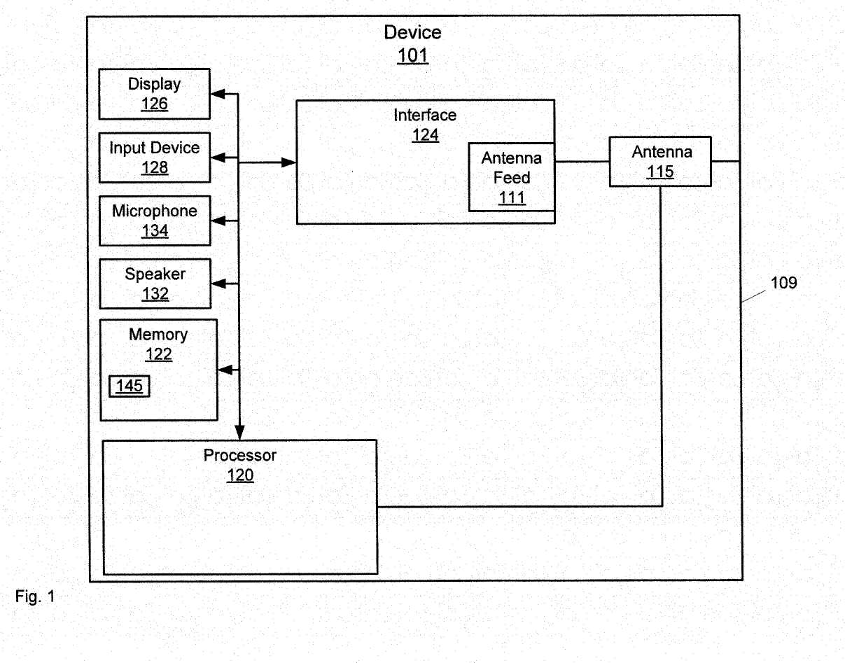

FIG. 1 depicts a schematic diagram of a mobile electronic device 101, referred to interchangeably hereafter as device 101. Device 101 comprises: a chassis 109 comprising a ground plane; an antenna feed 111, and a frequency tunable antenna 115 connected to the antenna feed 111, described in further detail below. Frequency tunable antenna 115 will be interchangeably referred to hereafter as antenna 115. Device 101 can be any type of electronic device that can be used in a self-contained manner to communicate with one or more communication networks using antenna 115. Device 101 includes, but is not limited to, any suitable combination of electronic devices, communications devices, computing devices, personal computers, laptop computers, portable electronic devices, mobile computing devices, portable computing devices, tablet computing devices, laptop computing devices, desktop phones, telephones, PDAs (personal digital assistants), cellphones, smartphones, e-readers, internet-enabled appliances and the like. Other suitable devices are within the scope of present implementations. Device hence further comprise a processor 120, a memory 122, a display 126, a communication interface 124 that can optionally comprise antenna feed 111, at least one input device 128, a speaker 132 and a microphone 134. Processor 120 is also in communication with one or more switches of antenna 115, as described in further detail below.

It should be emphasized that the structure of device 101 in FIG. 1 is purely an example, and contemplates a device that can be used for both wireless voice (e.g. telephony) and wireless data communications (e.g. email, web browsing, text, and the like). However, FIG. 1 contemplates a device that can be used for any suitable specialized functions, including, but not limited, to one or more of, telephony, computing, appliance, and/or entertainment related functions.

Device 101 comprises at least one input device 128 generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from input device 128 is received at processor 120 (which can be implemented as a plurality of processors, including but not limited to one or more central processors (CPUs)). Processor 120 is configured to communicate with a memory 122 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 122 and used by processor 120 which makes appropriate utilization of volatile storage during the execution of such programming instructions. Those skilled in the art will now recognize that memory 122 is an example of computer readable media that can store programming instructions executable on processor 120. Furthermore, memory 122 is also an example of a memory unit and/or memory module.

Memory 122 further stores an application 145 that, when processed by processor 120, enables processor 120 to: communicate with one or more switches at antenna 115 to select one or more inductors for tuning at least one resonance of antenna 115. Memory 122 storing application 145 is an example of a computer program product, comprising a non-transitory computer usable medium having a computer readable program code adapted to be executed to implement a method, for example a method stored in application 145.

Processor 120 can be further configured to communicate with display 126, and microphone 134 and speaker 132. Display 126 comprises any suitable one of, or combination of, CRT (cathode ray tube) and/or flat panel displays (e.g. LCD (liquid crystal display), plasma, OLED (organic light emitting diode), capacitive or resistive touchscreens, and the like). Microphone 134, comprises any suitable microphone for receiving sound and converting to audio data. Speaker 132 comprises any suitable speaker for converting audio data to sound to provide one or more of audible alerts, audible communications from remote communication devices, and the like. In some implementations, input device 128 and display 126 are external to device 101, with processor 120 in communication with each of input device 128 and display 126 via a suitable connection and/or link.

Processor 120 also connects to communication interface 124 (interchangeably referred to interchangeably as interface 124), which can be implemented as one or more radios and/or connectors and/or network adaptors, configured to wirelessly communicate with one or more communication networks (not depicted) via antenna 115. It will be appreciated that interface 124 is configured to correspond with network architecture that is used to implement one or more communication links to the one or more communication networks, including but not limited to any suitable combination of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like, wireless data, Bluetooth links, NFC (near field communication) links, WLAN (wireless local area network) links, WiFi links, WiMax links, packet based links, the Internet, analog networks, the PSTN (public switched telephone network), access points, and the like, and/or a combination.

Specifically, interface 124 comprises radio equipment (i.e. a radio transmitter and/or radio receiver) for receiving and transmitting signals using antenna 115. It is further appreciated that, as depicted, interface 124 comprises antenna feed 111, which alternatively can be separate from interface 124.

It is yet further appreciated that device 101 comprises a power source, not depicted, for example a battery or the like. In some implementations the power source can comprise a connection to a mains power supply and a power adaptor (e.g. and AC-to-DC (alternating current to direct current) adaptor).

It is yet further appreciated that device 101 further comprises an outer housing which houses components of device 101, including chassis 109. Chassis 109 can be internal to the outer housing and be configured to provide structural integrity to device 101. Chassis 109 can be further configured to support components of device 101 attached thereto, for example, display 126. In specific implementations chassis 109 can comprise one or more of a conducting material and a conducting metal, such that chassis 109 forms a ground and/or a ground plane of device 101; in alternative implementations, at least a portion of chassis 109 can comprise one or more of a conductive covering and a conductive coating which forms the ground plane.

In any event, it should be understood that a wide variety of configurations for device 101 are contemplated.

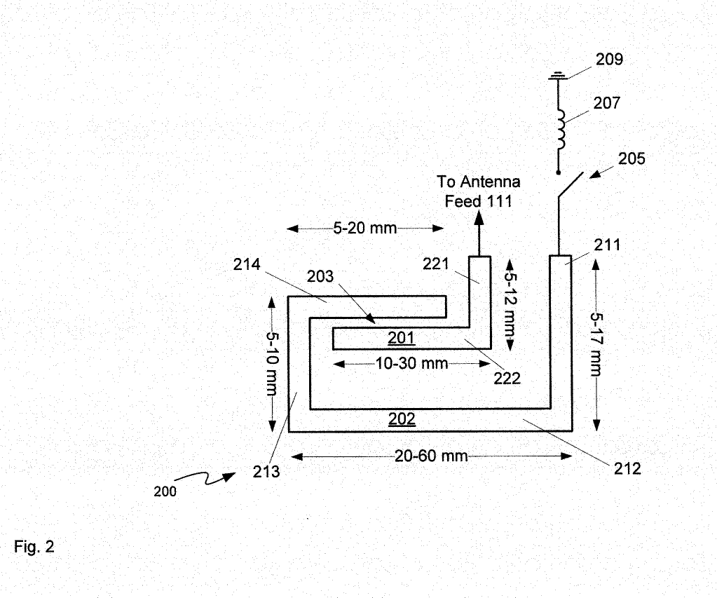

It is further appreciated that antenna 115 can comprise a wide variety of configurations as described hereafter. For example, attention is next directed to FIG. 2, which depicts non-limiting implementations of an antenna 200; in some implementations, antenna 115 can comprise antenna 200. Antenna 200 comprises: a first radiating arm 201 connected to antenna feed 111 (not depicted in FIG. 2); a second radiating arm 202 capacitively coupled to first radiating arm 201, for example across a gap 203; a switch 205 connected to second radiating arm 202, switch 205 having an open position and a closed position (as depicted in FIG. 2, switch 205 is in the open position); and an inductor 207 connected to switch 205 on one side and a ground 209 of device 101 on an opposite side. For example, inductor 207 can be connected to chassis 109 when chassis 109 comprises a ground and/or ground plane of device 101.

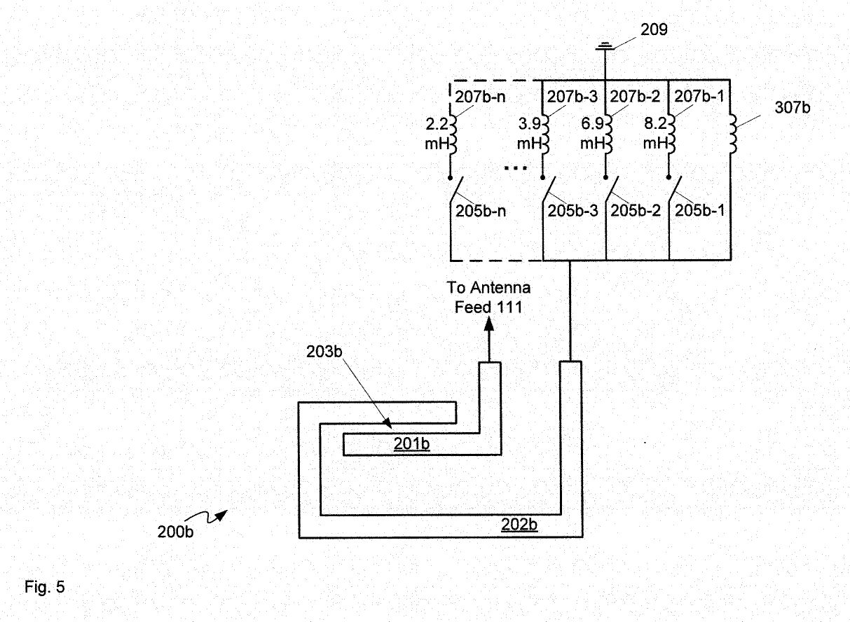

As previously depicted in FIG. 1, processor 120 (not depicted in FIG. 2) is in communication with antenna 200 and, specifically, switch 205. Processor 120 is generally configured to open and close switch 205 to tune a resonance frequency of at least second radiating arm 202 thereby changing a resonant length of second radiating arm 202 depending on whether inductor 207 is connected thereto, as described in detail below with respect to FIGS. 5 to 11. It is further appreciated that an input frequency from antenna feed 111 to antenna 200 can be controlled either by one or more of processor 120 and interface 124. In other words, as device 101 switches communication modes from one frequency band to another frequency band, one or more of processor 120 and interface 124 can cause an input frequency from antenna feed 111 to antenna 200 to switch between a frequencies, and in conjunction with changing frequency, processor 120 can open or close switch 205 to tune a resonance frequency of antenna 200.

In general, a respective size and shape of each of first radiating arm 201 and second radiating arm 202, and gap 203 for capacitive coupling there between, is chosen such that first radiating arm 201 and second radiating arm 202 resonate in at least the following frequency ranges: about 700 to about 960 MHz, about 1710 MHz to about 2170 MHz, and about 2500 MHz to about 2700 MHz; wherein the positions of resonances are tunable based on an inductance of inductor 207.

For example, in specific non-limiting implementations, second radiating arm 202 comprises four connected traces, 211, 212, 213, 214, with traces 212, 213, 214 forming a U-shape, and trace 211 connecting trace 212 to switch 205 in an L-shape with trace 212. In specific non-limiting implementations, trace 211 can have a length between about 5 mm to about 17 mm; in certain non-limiting implementations a length of a trace 211 can be about 16.2 mm. Furthermore, trace 212 can have a length between about 20 mm to about 60 mm, trace 213 can have a length between about 5 mm to about 10 mm, and trace 214 can have a length between about 5 mm to about 20 mm. Further, first radiating arm 201 can be L-shaped comprising traces 221, 222; trace 221 can have a length between about 5 mm to about 12 mm, and trace 222 can have a length between about 10 mm to about 30 mm. A width of each trace 211, 212, 213, 214, 221, 222 can be between about 2 mm and about 15 mm. Second radiating arm 202 can be coupled to first radiating arm 201 across gap 203 between traces 214, 222, and gap 203 can range from about 0.5 mm to about 2 mm. However, the dimensions of first radiating arm 201 and second radiating arm 202 can be chosen by one or more of experimentally, heuristically, trial and error, using antenna design software and the like; in general, a wide range of shapes and dimensions are within the scope of present implementations.

For example, in some implementations, second radiating arm 202 can also be L-shaped, comprising traces 211, 212, but not traces 213, 214, with trace 212 capacitively coupled to trace 222 across a gap similar to gap 203. Further, while as depicted trace 214 is located “above” trace 222, in other implementations, trace 222 can be located “above” trace 214; however the term “above” is appreciated to be for illustrative purposes only, relative only to FIG. 2, and is not meant to mean that one of traces 214, 222 are above the other with respect to the earth. When second radiating arm 202 is L-shaped, trace 212 therod can be located “above” or “below” trace 222 of first radiating arm 201, “above” and “below” again being relative to FIG. 2; further in these implementations, first radiating arm 201 can be as depicted, or can be a mirror-image thereof.

Yet further geometric configurations are within the scope of present implementations. For example, while as depicted trace 221 is connectable to antenna feed 111, in other implementations trace 222 can be connectable to antenna feed 111, for example at an end opposite trace 221. Further, while switch 205 is depicted as extending from a longitudinal axis of trace 211, in other implementations, switch 205 can extend from trace 211 in any direction that does not interfere with operation of antenna 200.

It is further appreciated that antenna 200 can be at least partially integrated into chassis 109, a housing of device 101 and the like.

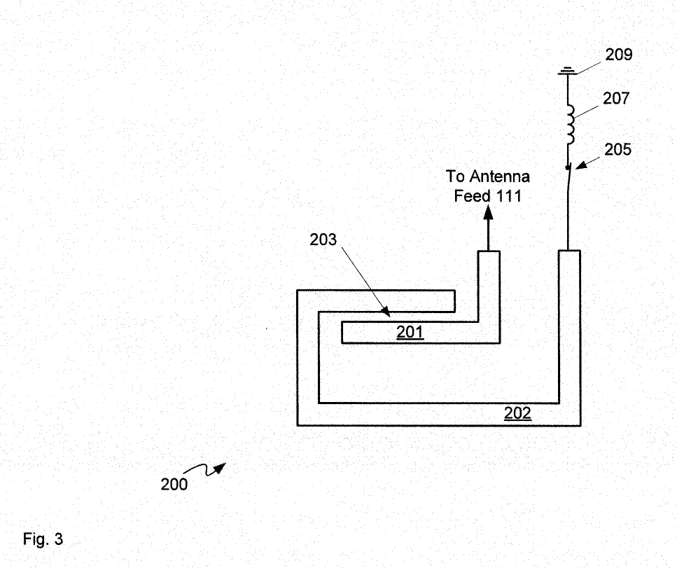

Attention is next directed to FIG. 3 which depicts antenna 200 with switch 205 in the closed position, which increases a resonant length of second radiating arm 202 and generally affects a resonance of each of first radiating arm 201 and second radiating arm 202, as described in further detail below. For example, as second radiating arm 202 is connected to inductor 207 in the closed position, inductor 207 generally increases a resonant length of second radiating arm 202 thereby decreasing a frequency at which second radiating arm 202 resonates; in general, a higher a value of inductance of inductor 207, a lower a resonance frequency of second radiating arm 202; in other words, the higher the inductance of inductor 207, the longer the resonant length of second radiating arm 202 and the lower the resonance frequency.

In particular non-limiting implementations, an inductor 207 can be chosen that has an inductance in a range that includes, but is not limited to, about 2 nH to about 10 nH. However, any inductance is within the scope of present implementations, depending on a length of second radiating arm 202 and/or first radiating arm 201; indeed, an inductor 207 can be chosen that has an inductance in a range that includes, but is not limited to, about 0 nH to more than about 100 nH. Further, depending on the value of inductor 207, the resonance frequency of at least second radiating arm 202 is tunable to at least one of the following frequency bands, depending on an inductance of the inductor: about 700 MHz to about 746 MHz; about 746 MHz to about 787 MHz; about 824 MHz to about 94 MHz; and, about 880 MHz to about 960 MHz.

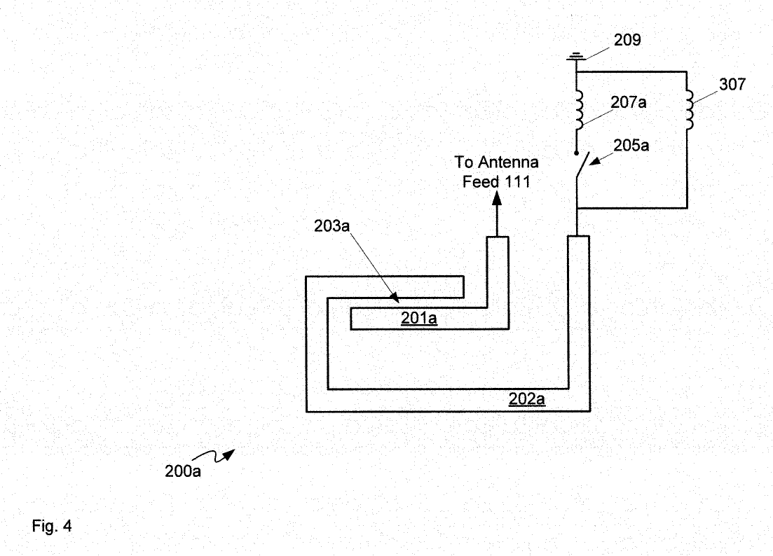

In some instances, switch 205 can be lossy; for example some switches can have an effective resistance of up to 1 ohm. Hence, attention is next directed to FIG. 4, which depicts an antenna 200a, substantially similar to antenna 200 with like elements having like number, but with an “a” appended thereto. Hence, antenna 200a comprises: a first radiating arm 201a connected to antenna feed 111 (not depicted in FIG. 4); a second radiating arm 202a capacitively coupled to first radiating arm 201a, for example across a gap 203a; a switch 205a connected to second radiating arm 202a, switch 205a having an open position and a closed position (as depicted in FIG. 4, switch 205a is in the open position); and an inductor 207a connected to switch 205a on one side and ground 209 of device 101 on an opposite side. Inductor 207a is substantially similar to inductor 207 described above.

While not depicted in FIG. 4, processor 120 is in communication with switch 205a. Processor 120 is generally configured to open and close switch 205a to tune a resonance frequency of at least second radiating arm 202a thereby changing a resonant length of second radiating arm 202a depending on whether inductor 207a is connected thereto. It is further appreciated that an input frequency from antenna feed 111 to antenna 200a can be controlled either by one or more of processor 120 and interface 124. In other words, as device 101 switches communication modes from one frequency band to another frequency band, one or more of processor 120 and interface 124 can cause an input frequency from antenna feed 111 to antenna 200a to switch between frequencies, and in conjunction with changing frequency, processor 120 can open or close switch 205a to tune a resonance frequency of antenna 200.

In some implementations antenna 115 can comprise antenna 200a.

In any event, to compensate for loss of switch 205a, antenna 200a further comprises a second inductor 307 connecting second radiating arm 202 to ground 209 in series, second inductor 307 connected in parallel with inductor 207a, second radiating arm 207a configured to compensate for loss of switch 205a. In implementations where inductor 207a has an inductance in a range of about 2 nH to about 10 nH, second inductor 307 has an inductance in a range of about 0 nH to more than about 100 nH. However, any inductance is within the scope of present implementations, depending on a length of second radiating arm 202a and/or first radiating arm 201a; indeed, an inductor 307 can be chosen that has an inductance in a range that includes, but is not limited to, about 0 nH to more than about 100 nH.

While antennas 200, 200a each comprise one inductor 207, 207a and one respective switch 205, 205a, in other implementations, further inductors and further respective switches can be added to one or more of antennas 200, 200a. For example, attention is directed to FIG. 5, which depicts an antenna 200b, substantially similar to antenna 200a with like elements having like number, but with a “b” appended thereto rather than an “a”. Hence, antenna 200b comprises: a first radiating arm 201b connected to antenna feed 111 (not depicted in FIG. 5); a second radiating arm 202b capacitively coupled to first radiating arm 201b, for example across a gap 203b. Antenna 200b further comprises an optional inductor 307b, connecting second radiating arm 202b to ground 209, similar to inductor 307. However, in contrast to antennas 200, 200a, antenna 200b comprises a plurality of switches 205b-1, 205b-2, 205b-3 . . . 205b-n, and a respective plurality of inductors 207-1, 207b-2, 207b-3 . . . 207b-n. The plurality of switches 205b-1, 205b-2, 205b-3 . . . 205b-n are interchangeably referred to hereafter, collectively, as switches 205b, and generically as a switch 205b; similarly, the plurality of inductors 207-1, 207b-2, 207b-3 . . . 207b-n are interchangeably referred to hereafter, collectively, as inductors 207b, and generically as an inductor 207b.

Plurality of switches 205b are connected to second radiating arm 202b, each of plurality of switches 205b having a respective open position and a respective closed position, similar to switch 205. Each of plurality of inductors 207b are connectable to second radiating arm 202 via a respective switch 205b of plurality of switches 205b, and plurality of inductors 207b are connected in parallel to ground 209.

While not depicted in FIG. 5, it is appreciated that processor 120 is in communication with plurality of switches 205b, processor 120 further configured to open and close plurality of switches 205b to tune the resonance frequency of at least second radiating arm 202b thereby changing the resonant length of second radiating arm 202b depending on which of plurality of inductors 207b is connected thereto. It is further appreciated that an input frequency from antenna feed 111 to antenna 200 can be controlled either by one or more of processor 120 and interface 124. In other words, as device 101 switches communication modes from one frequency band to another frequency band, one or more of processor 120 and interface 124 can cause an input frequency from antenna feed 111 to antenna 200 to switch between frequencies, and in conjunction with changing frequency, processor 120 can open or close one or more of plurality of switches 205b to tune a resonance frequency of antenna 200.

In other words, by providing inductors 207b, each of which having a different inductance, a resonance frequency of at least second radiating arm 202b can be tuned by opening and closing switches 205b to select an inductor 207b to connect to second radiating arm 202b. For example, as depicted, plurality of inductors 207b comprises at least four inductors 207b, each of which can be chosen to tune at least a resonance frequency of second radiating arm 202b. Plurality of switches 205b can be chosen to open and close accordingly when controlled by processor 120. While a type of each of plurality of switches 205b is generally non-limiting, it is appreciated that plurality of switches 20b can comprise at least one of: a single pole four throw switch; a single pole double throw switch; the single pole double throw switch in parallel with a single pole single throw switch. Further, while four inductors 207b are depicted, it is appreciated that antenna 200b can include as few as one inductor 207b, as in antenna 200, and any number of inductors 207b depending on a degree of frequency tuning is desired for antenna 200b.

For example, a number inductors 207b can be chosen that correspond to channels of one or more of a communication network and a 4G LTE network, with an inductor 207b for each channel and/or an inductor 207b for each of one or more channels. A specific channel can be chosen by closing a switch 205b that corresponds to an inductor 207b for that channel. As some channels can be specific to a given region, processor 120 can be further configured to communicate with the communication network to determine which channels are used in a region where device 101 is presently located and select an inductor 207b accordingly; such communication can occur on channels different from the selectable channels. Hence, device 101 can be generally adapted for communication in a plurality of regions; consequently, an entity building and/or marketing and/or otherwise distributing device 101 need not have different builds for device 101 corresponding to different regions thereby decreasing resources needed in a supply chain for managing the manufacture and distribution of the different builds.

In specific non-limiting implementations, and as depicted in FIG. 5, plurality of inductors 207b includes: at least one inductor 207b-1 having an inductance of about 8.2 nH, at least one inductor 207b-2 having an inductance of about 6.8 nH; at least one inductor 207b-3 having an inductance of about 3.9 nH; and at least one inductor 207b-n having an inductance of about 2.2 nH. However, any inductance is within the scope of present implementations, depending on a length and/or resonant length of second radiating arm 202b and/or first radiating arm 201b; indeed, an inductor 207b can be chosen that has an inductance in a range that includes, but is not limited to, about 0 nH to more than about 100 nH. In other words, at least one of inductors 207b can be about 0 nH (i.e. at least one of inductors 207b can a 0 ohm resistor. The 0 ohm resistor can be useful for high bands (e.g. about 1710 MHz to about 2700 MHz) to reduce hand/head impact).

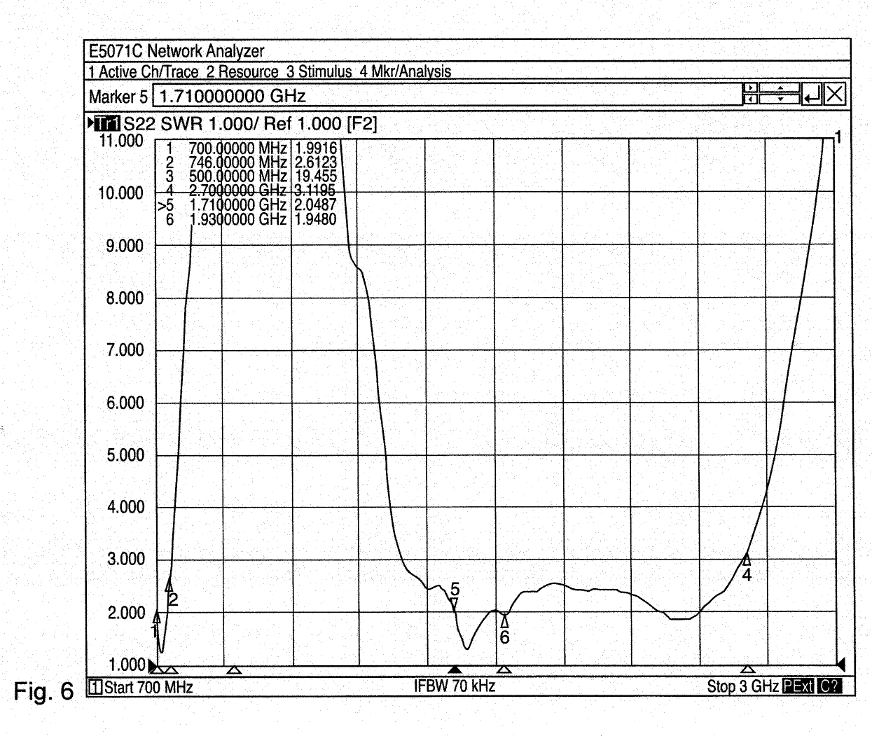

Tuning of antenna 200b is depicted in FIGS. 6, 7, 8 and 9, each of which depict a return-loss curve of antenna 200b when each of four different inductors 207b are connected to second radiating arm 202b; in other words, for each of FIGS. 6, 7, 8 and 9, one of switches 205b is closed while the remaining switches 205b are open, so that only one inductor 207b is connected to second radiating arm 202b.

Hence, attention is next directed to FIG. 6 which depicts a return-loss curve for specific non-limiting implementations of a successful prototype of antenna 200b between about 700 MHz and about 3000 MHz (or 3 GHz), with return-loss shown on the Y-axis and frequency shown on the x-axis. In depicted implementations, switch 205b-1 is closed while the remaining switches 205b are open, such that only inductor 207b-1 having a inductance of about 8.2 nH connects second radiating arm 202b to ground 209.

From FIG. 6, it is apparent that antenna 200b and/or second radiating arm 202b includes a resonance in the range of about 700 MHz to about 746 MHz with a peak at about 720 MHz (e.g. including point 1 at about 700 MHz, point 2 at about 746 MHz). It is further apparent that first radiating arm 201b and second radiating arm 202b (and/or antenna 200b) are configured to resonate in a first frequency range from about 1710 MHz to about 2170 MHz (e.g. including point 5 at about 1710 MHz and point 6 at about 1880 MHz), and in a second frequency range from about 2500 MHz to about 2700 MHz (e.g. including point 4 at about 2700 MHz). There is a relative dead zone between about 870 MHz to about 1100 MHz (e.g. including point 3 at about 900 MHz).

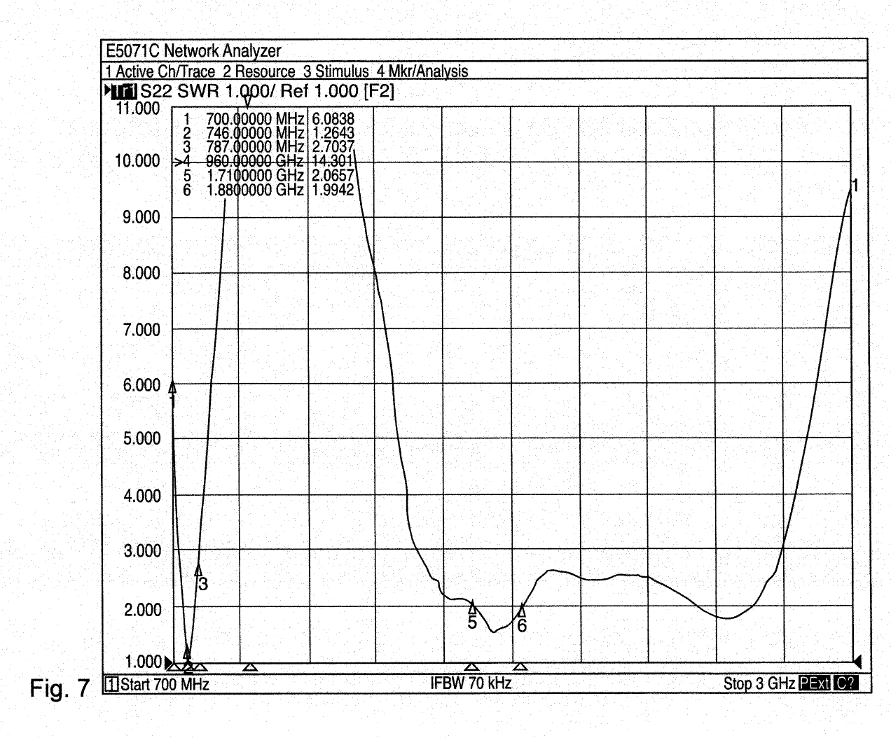

Attention is next directed to FIG. 7, which depicts a return-loss curve for specific non-limiting implementations of the successful prototype of antenna 200b, similar to FIG. 6. However, in FIG. 7, switch 205b-2 is closed while the remaining switches 205b are open, such that only inductor 207b-2 having an inductance of about 6.8 nH connects second radiating arm 202b to ground 209.

From FIG. 7, it is apparent that antenna 200b and/or second radiating arm 202b includes a resonance in the range of about 746 MHz to about 787 MHz with a peak at about 746 MHz (e.g. including point 1 at about 700 MHz, point 2 at about 746 MHz, and point 3 at about 787 MHz). In other words, in comparison to FIG. 6, when an inductor 207b-2 of lower inductance than inductor 207b-1 connects second radiating arm 202b to ground 209, the lowest frequency resonance shifts to a higher frequency as the resonant length of second radiating arm 202b is shorter.

It is further apparent from FIG. 7 that first radiating arm 201b and second radiating arm 202b (and/or antenna 200b) are further configured to resonate in a first frequency range from about 1710 MHz to about 2170 MHz (e.g. including point 5 at about 1710 MHz and point 6 at about 1880 MHz), and in a second frequency range from about 2500 MHz to about 2700 MHz. There is a relative dead zone between about 900 MHz to about 1100 MHz. Comparing FIGS. 6 and 7, it is apparent that the change in inductor 207b has had little effect on resonances in regions of about 1710 MHz to about 2170 MHz, about 2500 MHz to about 2700 MHz.

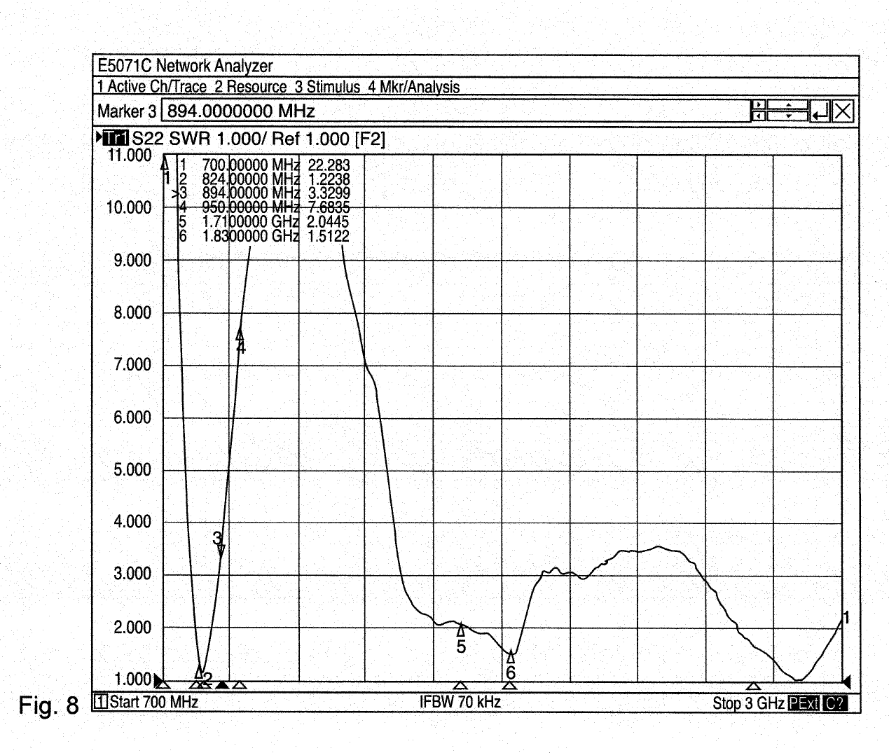

Attention is next directed to FIG. 8, which depicts a return-loss curve for specific non-limiting implementations of the successful prototype of antenna 200b, similar to FIGS. 6 and 7. However, in FIG. 8, switch 205b-3 is closed while the remaining switches 205b are open, such that only inductor 207b-3 having an inductance of about 3.9 nH connects second radiating arm 202b to ground 209.

From FIG. 8, it is apparent that antenna 200b and/or second radiating arm 202b includes a resonance in the range of about 824 MHz to about 894 MHz with a peak at about 824 MHz (e.g. including point 2 at about 824 MHz, point 3 at about 894 MHz, and point 4 at about 960 MHz). In other words, in comparison to FIGS. 6 and 7, when an inductor 207b-3 of lower inductance than inductors 207b-1, 207b-2 connects second radiating arm 202b to ground 209, the lowest frequency resonance shifts to a higher frequency as the resonant length of second radiating arm 202b is shorter.

It is further apparent from FIG. 8 that first radiating arm 201b and second radiating arm 202b (and/or antenna 200b) are further configured to resonate in a first frequency range from about 1710 MHz to about 2170 MHz (e.g. including point 5 at about 1710 MHz and point 6 at about 1880 MHz), and in a second frequency range from about 2500 MHz to about 2700 MHz. There are also two relative dead zones below about 720 MHz (e.g. including point 1 at about 700 MHz), and between about 1000 MHz to about 1100 MHz. Comparing FIGS. 7 and 8, it is apparent that the change in inductor 207b has an effect on resonances in regions of about 1710 MHz to about 2170 MHz, about 2500 MHz to about 2700 MHz. For example, the resonance in the range of about 2500 MHz to about 2700 MHz is becoming more pronounced, and the peak has shifted to higher frequency as compared to FIG. 7. Hence, to some degree, each of the first frequency range and the second frequency range can be tunable depending on an inductance of an inductor 207b.

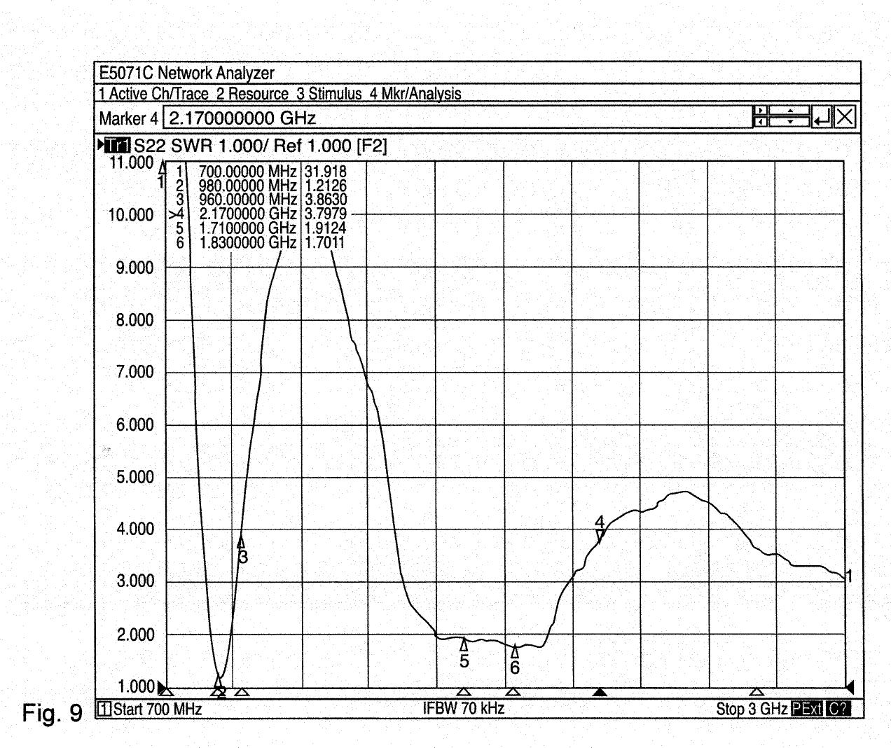

Attention is next directed to FIG. 9, which depicts a return-loss curve for specific non-limiting implementations of the successful prototype of antenna 200b, similar to FIGS. 6 to 8. However, in FIG. 9, switch 205b-n is closed while the remaining switches 205b are open, such that only inductor 207b-n having an inductance of about 2.2 nH connects second radiating arm 202b to ground 209.

From FIG. 8, it is apparent that antenna 200b and/or second radiating arm 202b includes a resonance in the range of about 880 MHz to about 960 MHz with a peak at about 880 MHz (e.g. including point 2 at about 880 MHz, and point 3 at about 960 MHz). In other words, in comparison to FIGS. 6 to 8, when an inductor 207b-n of lower inductance than inductors 207b-1, 207b-2, 270b-3 connects second radiating arm 202b to ground 209, the lowest frequency resonance shifts to a higher frequency as the resonant length of second radiating arm 202b is shorter.

It is further apparent from FIG. 9 that first radiating arm 201b and second radiating arm 202b (and/or antenna 200b) are further configured to resonate in a first frequency range from about 1710 MHz to about 2170 MHz (e.g. including point 5 at about 1710 MHz, point 6 at about 1880 MHz, and point 4 at about 2170 MHx), and in a second frequency range from about 2500 MHz to about 2700 MHz. There are also two relative dead zones below about 730 MHz (e.g. including point 1 at about 700 MHz), and at about 1100 MHz, though it is apparent that the dead zone around 1100 MHz is much narrower as compared to dead zones in the same region in FIGS. 6 to 8.

Comparing FIGS. 8 and 9, the change in inductor 207b has an effect on resonances in regions of about 1710 MHz to about 2170 MHz, and about 2500 MHz to about 2700 MHz. For example, the resonance in the range of about 2500 MHz to about 2700 MHz is becoming less pronounced, and the peak has shifted to a higher frequency as compared to FIG. 8. Further, resonance in the range of about 1710 MHz to about 2170 MHz has become much flatter as compared to FIG. 8. Hence, to some degree, each of the first frequency range and the second frequency range can be tunable depending on an inductance of an inductor 207b.

Hence, comparing the low frequency resonance of each of FIGS. 6 to 9, it is apparent that at least the low frequency resonance can be precisely tuned to a given resonance depending on an inductance of a selected inductor 207b. Each of the low frequency bands in FIGS. 6 to 9 can correspond to one or more 4G LTE channels in particular geographic regions. Hence, to communicate over a particular channel, processor 120 can close a corresponding switch 205b to connect a respective inductor 207b to second radiating arm 202b to cause a resonance in a frequency band corresponding to the particular channel.

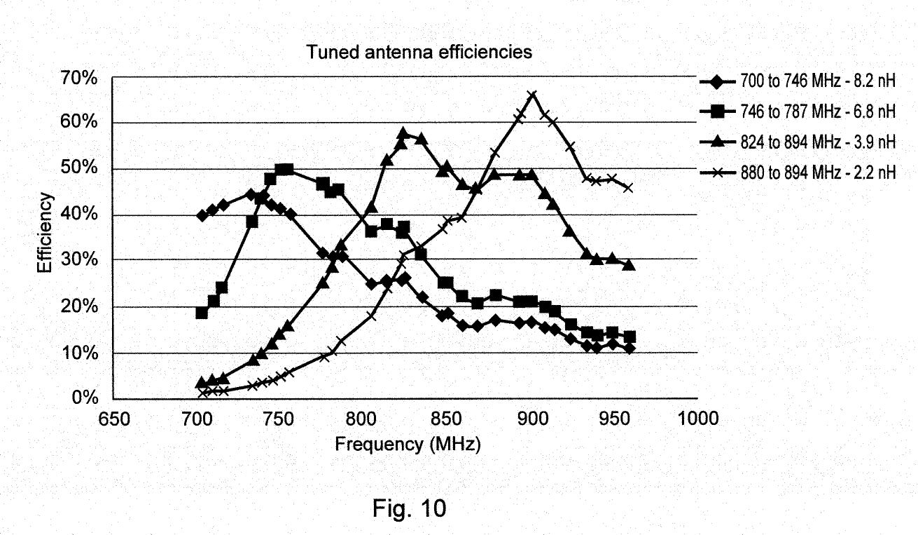

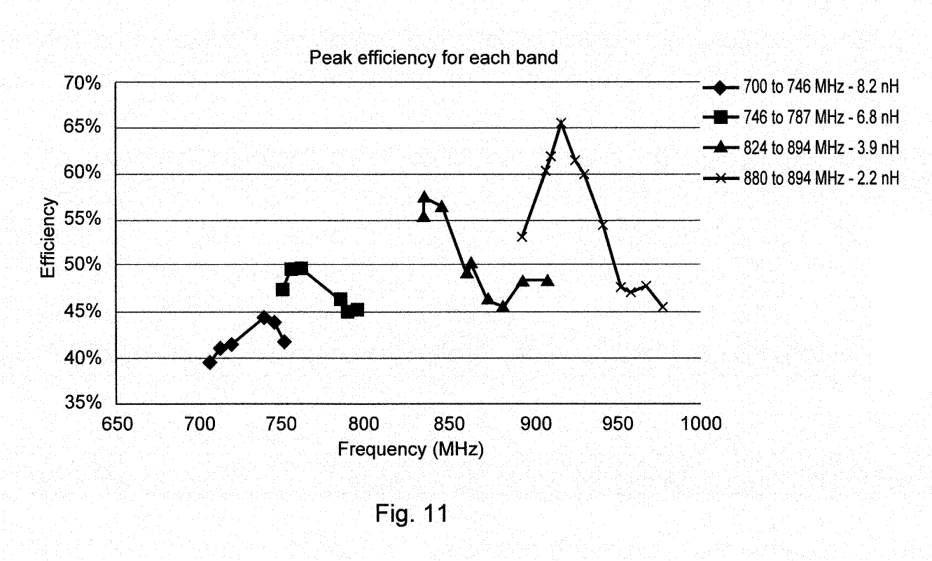

Furthermore, antenna 200b can achieve good efficiency over at least the frequency range of about 700 MHz to about 960 MHz. For example, attention is directed to FIGS. 10 and 11, each of depicts efficiency curves of the lower frequency band of specific non-limiting implementations the successful prototype of antenna 200b shown in FIGS. 6 to 9. Specifically, efficiency curves are depicted for each of inductor 207b-1 having inductance of about 8.2 nH (as in FIG. 6), inductor 207b-2 having an inductance of about 6.8 nH (as in FIG. 7), inductor 207b-3 having an inductance of about 3.9 nH (as in FIG. 8) and inductor 207b-n having an inductance of about 2.2 nH (as in FIG. 9) over a frequency range of about 650 MHz to about 960 MHz, with efficiency shown on the y-axis and frequency shown on the x-axis. FIGS. 10 and 11 are generally similar, however FIG. 11 depicts only a portion of each efficiency curve shown in FIG. 10, and over a narrower efficiency range (i.e. the efficiency scale in FIG. 10 ranges from 0% to 70%, while the efficiency scale in FIG. 11 ranges from about 35% to about 70%).

In any event, it is apparent that: for the band 700 MHz to 746 MHz for inductor 207b-1 of inductance 8.2 nH, the efficiency is between about 40% and 45%; for the band 746 MHz to 787 MHz for inductor 207b-2 of inductance 6.8 nH, the efficiency is between about 45% and 50%; for the band 824 MHz to 894 MHz for inductor 207b-3 of inductance 3.9 nH, the efficiency is between about 45% and 58%; and for the band 880 MHz to 894 MHz for inductor 207b-n of inductance 2.2 nH, the efficiency is between about 45% and 65%.

Persons skilled in the art will appreciate that there are yet more alternative implementations and modifications possible. For example, in yet further implementations, more than one inductor 207b can be selected. In other words, two or more of switches 205b can be closed to connect to or more of inductors 207b in parallel to one or more of reduce the number of inductors 207b at antenna 200b (e.g. inductors 207b-1 and 207b-2, having respective inductances of 8.2 nH and 6.8 nH, when connected in parallel, have an inductance of about 3.7 nH; hence inductor 207b-3 of 3.8 nH could be removed from antenna 200b and when an inductance of about 3.8 nH is desired at antenna 200b, inductors 207b-1 and 207b-2 can be connected in parallel) and allow for more control over the resonant length of second radiating arm 202b.

In any event, frequency tunable antennas are described herein that can replace a plurality of antennas at a mobile electronic device. The specific resonance bands of the antennas described herein can be varied by varying the dimensions of components of the antenna to advantageously align the bands with bands used by service providers to provide communication providers, and by providing a plurality of inductors and switches connected in parallel from a radiating arm of the antenna to ground; by opening and closing the switches, respective inductors can be connected to the radiating arm, which causes a resonant length of the radiating arm to lengthen, which tunes at least one resonance of the antenna. Further, the present antenna obviates the need to use different antennas for different bands in different regions as the width of resonance in higher frequency bands are wide enough to accommodate a plurality of channels in each band, while a lower frequency band is precisely tunable by connecting a specific inductor from the plurality of inductors using a respective switch.

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyrights whatsoever.

Persons skilled in the art will appreciate that there are yet more alternative implementations and modifications possible, and that the above examples are only illustrations of one or more implementations. The scope, therefore, is only to be limited by the claims appended here.

What is claimed is:

1. A device comprising:
a ground;
an antenna feed;
a first radiating arm connected to the antenna feed;
a second radiating arm capacitively coupled to the first radiating arm;
a switch connected to the second radiating arm, the switch having an open position and a closed position;
an inductor connected to the switch on one side and the ground on an opposite side; and,
a processor in communication with the switch, the processor configured to open and close the switch to tune a resonance frequency of at least the second radiating arm thereby changing a resonant length of the second radiating arm depending on whether the inductor is connected thereto.

2. The device of claim 1, further comprising a second inductor connecting the second radiating arm to the ground in series, the second inductor connected in parallel with the inductor, the second radiating arm configured to compensate for loss of the switch.

3. The device of claim 1, further comprising:
a plurality of switches, including the switch, and a plurality of inductors, including the inductor, the plurality of switches connected to the second radiating arm, each of the plurality of switches having a respective open position and a respective closed position, each of the plurality of inductors connectable to the second radiating arm via a respective switch of the plurality of switches, the plurality of inductors connected in parallel to the ground,
the processor in communication with the plurality of switches, the processor further configured to open and close the plurality of switches to tune the resonance frequency of at least the second radiating arm thereby changing the resonant length of the second radiating arm depending on which of the plurality of inductors is connected thereto.

4. The device of claim 3, wherein the plurality of inductors comprises at least four inductors, and the plurality of switches comprises at least one of: a single pole four throw switch; a single pole double throw switch; and the single pole double throw switch in parallel with a single pole single throw switch.

5. The device of claim 3, wherein the plurality of inductors includes at least one inductor having an inductance of about 8.2 nH.

6. The device of claim 3, wherein the plurality of inductors includes at least one inductor having an inductance of about 6.8 nH.

7. The device of claim 3, wherein the plurality of inductors includes at least one inductor having an inductance of about 3.9 nH.

8. The device of claim 3, wherein the plurality of inductors includes at least one inductor having an inductance of about 2.2 nH.

9. The device of claim 1, wherein the resonance frequency is tunable to at least one of the following frequency bands, depending on an inductance of the inductor:
about 700 MHz to about 746 MHz;
about 746 MHz to about 787 MHz;
about 824 MHz to about 94 MHz; and,
about 880 MHz to about 960 MHz.

10. The device of claim 1, wherein the inductor has an inductance in a range of about 0 nH to about 100 nH.

11. The device of claim 1, wherein the first radiating arm and the second radiating arm are further configured to resonate in a first frequency range from about 1710 MHz to about 2170 MHz, and in a second frequency range from about 2500 MHz to about 2700 MHz.

12. The device of claim 11, wherein each of the first frequency range and the second frequency range is tunable depending on an inductance of the inductor.

13. The device of claim 1, wherein the second radiating arm includes a trace that is about 16.2 mm long.

14. The device of claim 1, wherein the second radiating arm is coupled to the first radiating arm across a gap that in a range of about 0.5 mm to about 2 mm.

15. The device of claim 1, wherein a respective size and shape of each of the first radiating arm and the second radiating arm, and a gap for capacitive coupling there between, are chosen such the first radiating arm and the second radiating arm resonate in at least frequency ranges of: about 700 to about 960 MHz. about 1710 MHz to about 2170 MHz, and about 2500 MHz to about 2700 MHz; wherein the positions of resonances are tunable based on an inductance of the inductor.
